(19) United States
(12) Patent Application Publication
(10) Pub. No.: US 2006/0059666 A1
(43) Pub. Date: Mar. 23, 2006

(54) Cord holder

(76) Inventor: Catherine M. Senink, East St. Paul (CA)

Correspondence Address: Mr. Adrian D. Battison;Ade & Company, 1700-360 Main Street, Winnipeg, MB, R3C 3Z3, CA

(21) Appl. No.: 11/233,103

(22) Filed: Sep. 23, 2005

(30) Foreign Application Priority Data
Sep. 23, 2004 (CA) 2,482,269

(51) Int. Cl. F16G 11/00

(52) U.S. Cl. 24/132 R

(57) ABSTRACT

A cord holder is provided for use with a hand-held tool having a power cord. The cord holder includes a two component releasable fastener, preferably magnetic. One component of the fastener is mounted on a bracelet to be worn by a user. The other component is mounted on a cord retainer to be fastened to the cord. The power cord can be supported on the user's wrist or arm by the cord holder retainer while the user holds and manipulates the tool.

The present invention relates to the use of, hand-held power tools, and more particularly to devices for securing the power cords of the tools when in use.

### BACKGROUND OF THE INVENTION

In certain environments, for example in dental practices, numerous small, hand-held tools (polishers, drills, and cavitrons being examples) are employed that use long electrical cords to supply the necessary power. The cords tend to be of sufficient weight and length that they may cause fatigue of the user's arm and hand with prolonged use, as well as often providing a physical obstruction, potentially hindering the efficient delivery of services.

Prior attempts have been made to address the perceived need for tool cord supports. U.S. Pat. No. 3,155,298 to Brown discloses a supporting clip for use with the electric hair clippers cords, wherein the clip engages a user's breast pocket and serves as a hanger for a loop of the cord. U.S. Pat. No. 3,809,349 to Baedke teaches an elastic arm band including a clip for receiving a loop of a power cord, the elastic arm band worn on the arm wielding the power tool. U.S. Pat. No. 5,758,809 to Bonner teaches a cord holding harness, wherein the power cord is secured to the harness, and extends over the shoulder and down the back of a user. U.S. Pat. No. 6,336,578 to Maynard discloses a cord holder that engages the user's pocket or belt, and which holds a bight of the cord by means of a loop-and-hook arrangement.

While the prior art teaches means of addressing problems associated with the cords of power tools, these proposed solutions do not fully address the unique needs associated with smaller and more numerous tools as would be employed within a dental practice, where numerous devices may be used in rapid succession. The prior art fails to provide a quickly removable device with the light-weight construction that is desirable in some contexts, nor does it address the arm or hand fatigue that may occur in this type of setting.

### SUMMARY OF THE INVENTION

According to the present invention there is provided a cord holder for use with a hand-held tool having a power cord the cord holder comprising:

a releasable fastener having releasably attachable first and second fastener components;

a base member attached to the first fastener component for securing the first fastener component to an arm of a user; and

a cord retainer attached to the second fastener component for removably attaching the second fastener component to the power cord;

whereby the power cord can be supported on the user's arm during use of the tool.

The first fastener component may be removably mounted on or fixed to the base member, the former arrangement enabling the user to remove the first fastener component from the base member when it is desirable to do so, e.g. when the cord support is not required. This removable mounting may use a clamp. The base member is desirably attached to the user's wrist, as a bracelet encircling the wrist. The first and second fastener components are preferably magnetic pads that attract each other when brought into close proximity. In some embodiments, the cord retainer is a clamp.

To enable disinfecting or sterilizing the holder, base member and cord retainer may be fabricated from stainless steel or another suitable sterilizable material.

The base member is preferably adjustable to accommodate arms of different sizes.

The second fastener component may be slidably engaged with the cord retainer. In one embodiment the cord retainer has a slot within which the second fastener component is slideably engaged, enabling cord position adjustments.

The present invention provides a light-weight device that enables quick disengagement of the cord holder. The cord retainer can remain attached to the cord, and numerous cord retainer can be left attached to the cords of the various tools that might be required over a given period of time. By securing the cord to the user's wrist in this way, fatigue can also be effectively addressed.

Preferably the base member is for attachment to the arm is a loop or bracelet lying in a plane for surrounding the arm and wherein the cord retainer is arranged to hold the cord in a plane at right angles to the plane so that the cord at the cord retainer lies along or across the arm.

Preferably the base member is for attachment to the arm is a loop or bracelet lying in a plane for surrounding the arm and wherein the cord retainer is mounted on an arm portion projection outwardly radially of the loop so that the cord at the cord retainer is held spaced from the arm.

A detailed description of two exemplary embodiments of the present invention is given in the following. It is to be understood, however, that the invention is not to be construed as limited to these embodiments.

### BRIEF DESCRIPTION OF THE DRAWINGS

In the accompanying drawings, which illustrate exemplary embodiments of the present invention:

FIG. 1 is a perspective view of an exemplary embodiment of the present invention wherein the second fastener component is slideably engaged with the cord retainer.

FIG. 2 is a partially exploded perspective view of an exemplary embodiment of the present invention wherein the second fastener component is fixedly engaged with the cord retainer and the first fastener component is removably mounted on the base member.

### DETAILED DESCRIPTION OF EXEMPLARY EMBODIMENTS

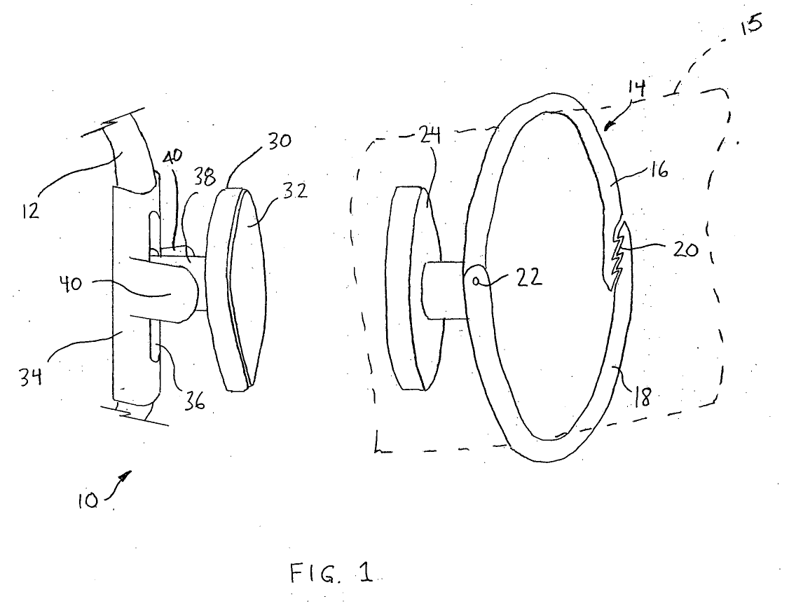

Referring to the accompanying drawings, and particularly to FIG. 1, there is illustrated a cord holder 10 according to the present invention. The cord holder 10 has a base member 14 for securing to an arm 15 of a user, a first fastener component 24 on the base member 14, a cord retainer 34 for removable attachment to the cord 12 of a power tool (not shown), and a second fastener component 30 on the cord retainer 34. In the illustrated exemplary embodiments, the first and second fastener components 24, 30 include magnetic pads 26, 32, respectively.

The base member 14, which roughly forms a bracelet in the illustrated exemplary embodiments, comprises first and second sections 16, 18 that are hingedly engaged to each other at one point at pivot 22, and engageable at an opposite point by means of ratchet teeth 20. As there are a series of teeth 20, the base member 14 can therefore be adjusted to comfortably fit different wrist sizes.

The second fastener component 30 is secured to the cord 12 by means of the cord retainer 34, which in the exemplary embodiments is a form of butterfly clamp. The clamp of cord retainer 34 includes finger pads 40 to enable opening of the clamp with a pinching action.

In the embodiment illustrated in FIG. 1, the second fastener component 30 is slideably engaged with the cord retainer 34. The second fastener component 30 is mounted on a shank 38 engaged in a slot 36 in the cord retainer 34.

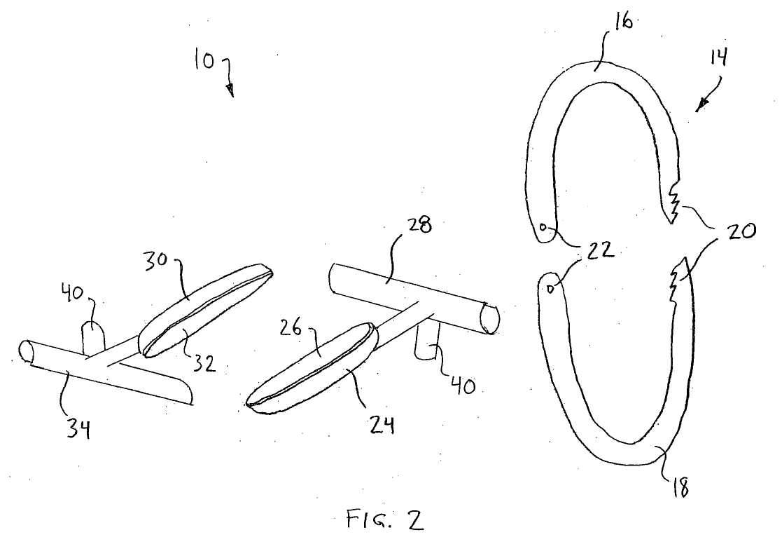

In the embodiment illustrated in FIG. 2, the second fastener component 30 is fixed to the cord retainer 34, and the first fastener component 24 is removably mounted on the base member 14 by a clamp 28, similar to the cord retainer clamp 34.

In use of the embodiment illustrated in FIG. 1, the user secures the base member 14 to his or her wrist by rotating the first and second sections 16, 18 about the pivot 22, the first and second sections 16, 18 engaging each other by means of the ratchet teeth 20 to enclose the user's wrist within the base member 14. The user then picks up a power tool, which is equipped with cord 12. The cord retainer 34 is connected to the cord 12. The fastener components 24 and 30 are then brought into engagement so that the two magnetic pads 26, 32 attract each other and provide a removable attachment of the base member 14 to the cord retainer 34. The user may then use the chosen tool while the weight of the cord 12 is now partially supported by the wrist. Where use of the tool can pull slightly on the cord 12, the slot 36 and shank 38 provide a degree of adjustment where necessary. When the user desires to cease use of the given tool, the first and second fastener components 24, 30 are pulled apart with sufficient force that the magnetic pads 26, 32 disengage. The tool may be set aside and, if desired, another tool with a cord retainer 34 can be selected. Numerous tools may be used with the present invention, each having a cord 12 provided with its own cord retainer 34.

In the exemplary embodiment illustrated in FIG. 2, the base member 14 is secured to the user's wrist as set out above. This embodiment is particularly useful where the user does not need to have the first fastener component 24 constantly attached to the base member 14. In this embodiment, the first fastener component 24 attaches to the base member 14 when desired by means of the clamp 28. The cord retainer 34 is engaged as set out above. With this embodiment, once the cord retainer 34 is attached to the cord 12 and the clamp 28 is attached to the base member 14, the cord holder may be used in the manner set out above.

While particular embodiments of the present invention have been described in the foregoing, it is to be understood that other embodiments are possible within the scope of the invention and are intended to be included herein. It will be clear to any person skilled in the art that modifications of and adjustments to this invention are possible without departing from the spirit of the invention as demonstrated through the exemplary embodiments. For example, the base member in the illustrated embodiments is fastened around the arm or wrist using the adjustability provided by ratchet teeth 20. It is to be understood that alternative adjustment means are known and may be employed. It is also to be understood that the base member may be attached to a part of the user's arm other than the wrist, for example above the elbow. Other features may likewise be altered. The invention is therefore to be considered limited solely by the scope of the appended claims.

1. A cord holder for use with a hand-held tool having a power cord, the cord holder comprising:
a releasable fastener having releasably engageable first and second fastener components;
a base member attached to the first fastener component for securing the first fastener component to an arm of a user; and
a cord retainer attached to the second fastener component for removably attaching the second fastener component to the power cord;
whereby the power cord can be supported on the user's arm during use

2. The cord holder of claim 1 wherein the first fastener component is removably mounted on the base member.

3. The cord holder of claim 1 wherein the first fastener component is fixedly mounted on the base member.

4. The cord holder of claim 1 wherein the base member is adapted to be secured to the wrist of the user's arm.

5. The cord holder of claim 4 wherein the base member is a bracelet for encircling the wrist.

6. The cord holder of claim 1 wherein the first and second fastener components are magnetic pads that attract each other.

7. The cord holder of claim 1 wherein the cord retainer is a clamp.

8. The cord holder of claim 2 wherein the first fastener component is removably mounted on the base member by means of a clamp on the first fastener component.

9. The cord holder of claim 1 wherein the base member and cord retainer are stainless steel.

10. The cord holder of claim 1 wherein the second fastener component is slideably engaged with the cord retainer.

11. The cord holder of claim 10 wherein the cord retainer comprises a slot within which the second fastener component is slideably engaged.

12. The cord holder of claim 1 wherein the base member is adjustable to accommodate differing arm sizes.

13. The cord holder of claim 1 wherein the base member is for attachment to the arm is a loop lying in a plane for surrounding the arm and wherein the cord retainer is arranged to hold the cord in a plane at right angles to the plane so that the cord at the cord retainer lies along or across the arm.

14. The cord holder of claim 1 wherein the base member is for attachment to the arm is a loop lying in a plane for surrounding the arm and wherein the cord retainer is mounted on an arm portion projection outwardly radially of the loop so that the cord at the cord retainer is held spaced from the arm.
